(19) United States
(12) Patent Application Publication
(10) Pub. No.: US 2026/0192664 A1
(43) Pub. Date: Jul. 9, 2026

(54) VISUAL SIGNAL GENERATION METHOD AND VEHICLE

(71) Applicant: Nissan Motor Co., Ltd., Yokohama-shi, Kanagawa (JP)

(72) Inventors: Mitsuhiro MAKITA, Kanagawa (JP); Atsushi TAKAMATSU, Kanagawa (JP)

(21) Appl. No.: 19/132,396

(22) PCT Filed: Dec. 1, 2022
(86) PCT No.: PCT/JP2022/044471

§ 371 Date: May 23, 2025

(51) Int. Cl. B60K 35/21; B60K 35/40

(52) U.S. Cl. CPC B60K 35/21; B60K 35/40

(57) ABSTRACT

A visual signal generation method is performed to improve visibility and readability in a gaze in a central vision of a passenger while the passenger is gazing at an object in a vehicle interior of a vehicle. The visual signal generation method includes detecting acceleration of a vehicle by a sensor; and outputting a visual signal flowing along a direction of the acceleration from an indicator visually recognizable by a passenger of the vehicle based on an output signal from the sensor.

### CROSS-REFERENCE TO RELATED APPLICATIONS

This application is a U.S. national stage application of International Application No. PCT/JP2022/044471, filed on Dec. 1, 2022.

### BACKGROUND

### Technical Field

The present invention relates to a visual signal generation method and a vehicle.

### Background Information

Japanese Patent Application Publication No. 2021-023539 A (hereinafter referred to as In PTL 1) discloses a technology for correcting visual information and reducing motion sickness of a passenger who is not viewing the vehicle exterior by compensating for an optical flow generated when the passenger is able to visually recognize a vehicle motion by peripheral vision by generating a light emission pattern of a light string on an eyeglass frame.

### SUMMARY

However, since the technology in PTL 1 adds an optical flow in accordance with vehicle speed, there is a risk that the technology constantly generates an optical flow in the peripheral vision during travel, as a result of which visibility and readability in a gaze in the central vision is reduced.

An object of the present invention is to, while a passenger is gazing at an object in a vehicle interior of a vehicle, prevent visibility and readability in the gaze in a central vision of the passenger from being reduced due to vehicle behavior.

According to an aspect of the present invention, there is provided a visual signal generation method including: detecting acceleration of a vehicle by a sensor; and outputting a visual signal flowing along a direction of the acceleration from an indicator visually recognizable by a passenger of the vehicle based on an output signal from the sensor.

According to an aspect of the present invention, it is possible to, while a passenger is gazing at an object in a vehicle interior of a vehicle, prevent visibility and readability in the gaze in a central vision of the passenger from being reduced due to vehicle behavior.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

Referring now to the attached drawings which form a part of this original disclosure, illustrative embodiments are shown.

FIG. 1 is a schematic configuration diagram of an example of an optical flow generation device of an embodiment;

FIG. 2 is a schematic diagram of an arrangement example of a longitudinal direction optical flow generation unit and a lateral direction optical flow generation unit;

FIGS. 3A and 3B are schematic diagrams of influence of acceleration of a vehicle on visibility and readability for a passenger;

FIGS. 4A and 4B are schematic diagrams of a method for providing optical flows when the vehicle accelerates and decelerates, respectively;

FIGS. 5A and 5B are schematic diagrams of a method for providing optical flows when the vehicle turns right and turns left, respectively; and

FIG. 6 is a flowchart of an example of an optical flow generation method of the embodiment.

### DETAILED DESCRIPTION OF EMBODIMENTS

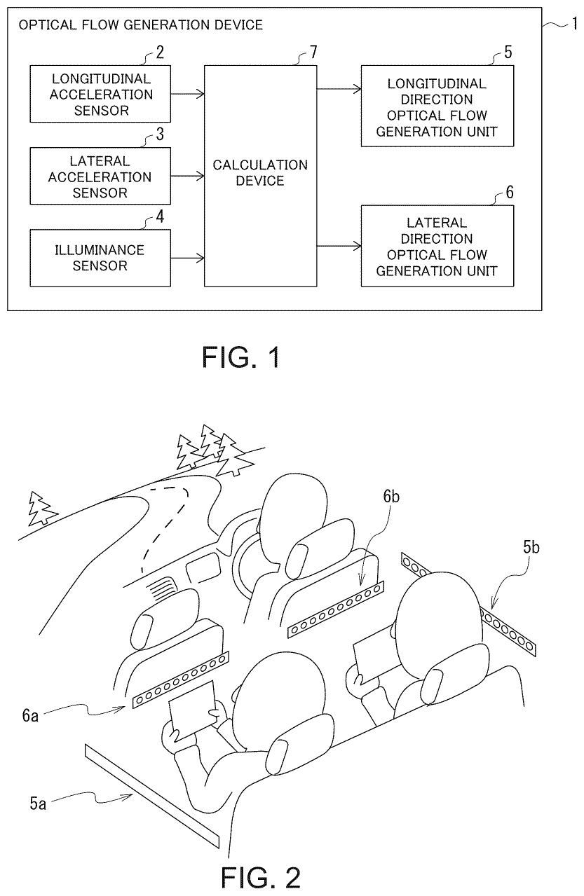

FIG. 1 is a schematic configuration diagram of an optical flow generation device of an embodiment. An optical flow generation device 1 is installed in a vehicle and is used to generate an optical flow matching a vehicle motion in a visual field of a passenger and thereby prevent visibility and readability in a gaze in central vision of the passenger who is gazing at an object in a vehicle interior from being reduced due to the vehicle motion. The optical flow generation device 1 includes a longitudinal acceleration sensor 2, a lateral acceleration sensor 3, an illuminance sensor 4, a longitudinal direction optical flow generation unit 5, a lateral direction optical flow generation unit 6, and a calculation device 7.

The longitudinal acceleration sensor 2 detects acceleration in a longitudinal direction (hereinafter, sometimes referred to as “longitudinal acceleration”) generated in the vehicle and outputs an output signal indicating a detection result of the longitudinal acceleration to the calculation device 7.

The lateral acceleration sensor 3 detects acceleration in a lateral direction (vehicle width direction) (hereinafter, sometimes referred to as “lateral acceleration”) generated in the vehicle and outputs an output signal indicating a detection result of the lateral acceleration to the calculation device 7.

The illuminance sensor 4 detects illuminance in the vehicle interior (that is, brightness in the vehicle interior) and outputs an output signal indicating the illuminance in the vehicle interior to the calculation device 7.

The longitudinal direction optical flow generation unit 5 is an indicator configured to output a visual signal flowing in the longitudinal direction of the vehicle. The lateral direction optical flow generation unit 6 is an indicator configured to output a visual signal flowing in the lateral direction of the vehicle. The longitudinal direction optical flow generation unit 5 and the lateral direction optical flow generation unit 6 are arranged at positions visually recognizable by the passenger in the vehicle interior of the vehicle.

The longitudinal direction optical flow generation unit 5 is capable of generating an optical flow flowing in the longitudinal direction of the vehicle in a peripheral visual field of the passenger by outputting a visual signal flowing in the longitudinal direction of the vehicle. In addition, the lateral direction optical flow generation unit 6 is capable of generating an optical flow flowing in the lateral direction of the vehicle in the peripheral visual field of the passenger by outputting a visual signal flowing in the lateral direction of the vehicle.

The visual signals generated by the longitudinal direction optical flow generation unit 5 and the lateral direction optical flow generation unit 6 may be light providing the passenger with visual stimulus or a visual pattern, such as a figure, a pattern, and an image.

For example, the longitudinal direction optical flow generation unit 5 may include a light emitting element array in which a plurality of light emitting elements are arranged in the longitudinal direction of the vehicle (a strip-shaped light emitting element), output a visual signal flowing in the longitudinal direction of the vehicle by turning on the light emitting elements in order in the longitudinal direction of the vehicle, and provide the passenger with a visual stimulus causing an optical flow flowing in the longitudinal direction to be generated in the peripheral visual field of the passenger.

In addition, for example, the lateral direction optical flow generation unit 6 may include a light emitting element array in which a plurality of light emitting elements are arranged in the lateral direction of the vehicle (a strip-shaped light emitting element), output a visual signal flowing in the lateral direction of the vehicle by turning on the light emitting elements in order in the lateral direction of the vehicle, and provide the passenger with a visual stimulus causing an optical flow flowing in the lateral direction to be generated in the peripheral visual field of the passenger. For example, the longitudinal direction optical flow generation unit 5 and the lateral direction optical flow generation unit 6 may include light emitting diodes (LEDs) as the plurality of light emitting elements.

A means by which the longitudinal direction optical flow generation unit 5 and the lateral direction optical flow generation unit 6 provide the passenger with a visual stimulus is not limited to a light emitting element, and is only necessary to be a means that generates a visual stimulus visually recognizable by the passenger. For example, the means may be a means that generate an optical flow flowing in a desirable direction by changing reflecting surfaces of a plurality of elements or colors of a plurality of elements arranged in a direction of an optical flow to be generated, in order.

FIG. 2 is a schematic diagram of an arrangement example of the longitudinal direction optical flow generation unit 5 and the lateral direction optical flow generation unit 6.

When optical flow generation units are arranged around rear seats, lateral direction optical flow generation units 6a and 6b may be arranged on a back surface of a left front seat and a back surface of a right front seat in accordance with the right and left rear seats, respectively. In addition, longitudinal direction optical flow generation units 5a and 5b may be arranged on interior sides of a left rear door and a right rear door, respectively.

When the optical flow generation units are arranged around the front seats, attaching the lateral direction optical flow generation units 6a and 6b on a dashboard or the like enables a passenger who is gazing at vehicle navigation equipment or the like in front of the front seats to be served. In addition, the longitudinal direction optical flow generation units 5a and 5b may be arranged on interior sides of a left front door and a right front door, respectively.

FIG. 1 is now referred to. The calculation device 7 is an electronic circuit configured to control the longitudinal direction optical flow generation unit 5 and the lateral direction optical flow generation unit 6 based on the longitudinal acceleration sensor 2, the lateral acceleration sensor 3, and the illuminance sensor 4.

For example, the calculation device 7 may be a computer including a processor and peripheral components, such as a storage device. The processor may be, for example, a central processing unit (CPU) or a micro-processing unit (MPU). The storage device may include a semiconductor memory device, a magnetic storage device, an optical storage device, or the like.

The storage device may include registers, a cache memory, and a memory, such as a read only memory (ROM) and a random access memory (RAM), that is used as a main storage device.

Functions of the calculation device 7 described below are achieved by, for example, the processor executing computer programs stored in the storage device. Note that the calculation device 7 may be formed by dedicated hardware for executing various types of information processing described below. For example, the calculation device 7 may include a functional logic circuit that is implemented in a general-purpose semiconductor integrated circuit. For example, the calculation device 7 may include a programmable logic device (PLD) such as a field-programmable gate array (FPGA).

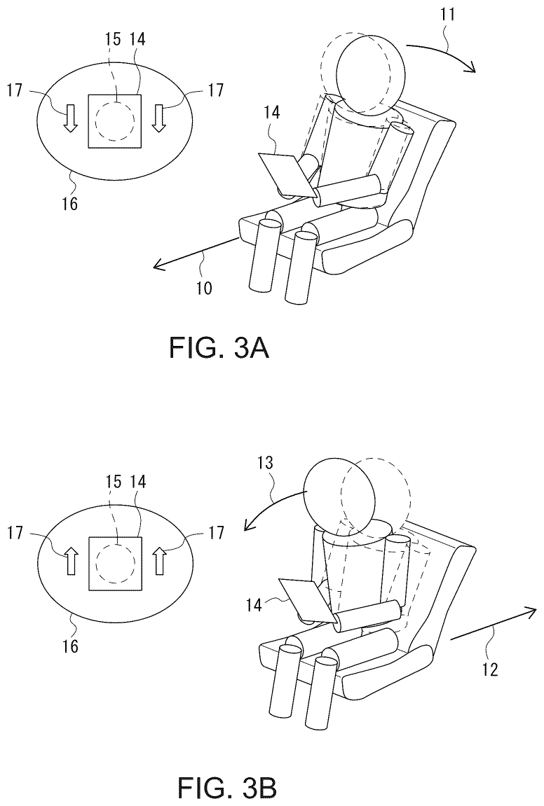

Next, with reference to FIGS. 3A and 3B, influence of a vehicle accelerating and decelerating in a situation where a passenger is gazing at an object in the vehicle interior on the visual sense will be described.

When the passenger is gazing at an object in the vehicle interior (for example, reading a book or viewing a smartphone in the vehicle interior), the head, which is farthest from a seating surface of the seat, among regions of the body of the passenger is easily moved regardless of whether the acceleration is longitudinal acceleration or lateral acceleration.

For example, in the example in FIG. 3A, when forward acceleration is generated as illustrated by an arrow 10 due to the vehicle accelerating, rearward inertial acceleration acts on the passenger and the head of the passenger is tilted backward in a direction of an arrow 11. In the example in FIG. 3B, when rearward acceleration is generated as illustrated by an arrow 12 due to the vehicle decelerating, forward inertial acceleration acts on the passenger and the head of the passenger is tilted forward in a direction of an arrow 13.

On the other hand, a gaze target 14 (a book or a smartphone) held by hand is more unlikely to be moved than the head. Since on this occasion, the passenger is gazing at the gaze target 14 around a central vision 15 of the visual sense, there is a risk that when the gaze in the central vision 15 does not work well, visibility and readability are reduced. Therefore, in order for the eyes to continue gazing at a gazed point, the eyes are caused to move in such a manner as to cancel a pitch motion or a roll motion of the head, in which the eyes are included, generated by vehicle acceleration.

On the other hand, in an area of a peripheral visual field 16, capability of the visual sense in detecting a motion is high though an image is not formed into a clear image, and an opt-kinetic-response (OKR) that, upon detection of the motion (an optical flow 17), subconsciously corrects a direction of the eyes occurs.

When at the time of gazing at the gaze target 14, the optical flow 17 associated with a head motion occurs in the peripheral visual field 16, which is located away from the central vision 15, in the gaze, there is a possibility that an opt-kinetic-response occurs, and as a result, it is conceivable that the gaze in the central vision 15 is influenced and readability and visibility deteriorate.

Therefore, in order to reduce influence of the optical flow 17 due to the head motion, the calculation device 7 generates an optical flow in the reverse direction to the direction of the optical flow 17, using the longitudinal direction optical flow generation unit 5 and/or the lateral direction optical flow generation unit 6.

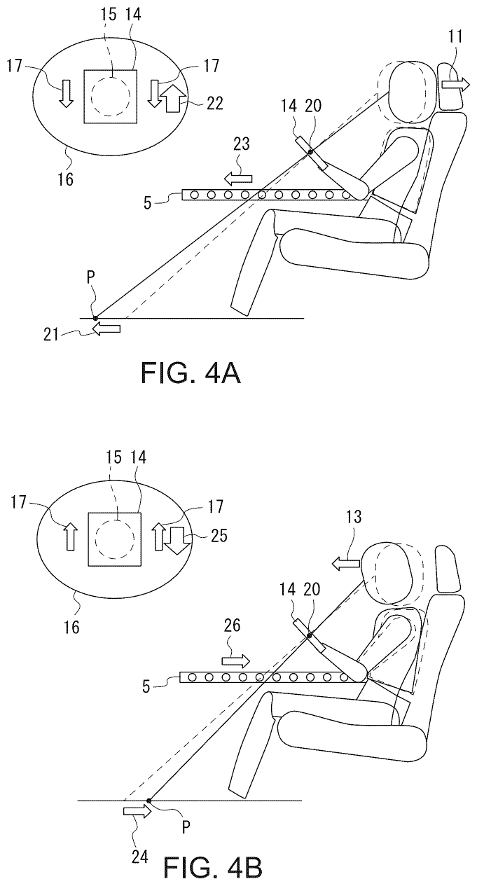

FIG. 4A is a schematic diagram of a method for providing an optical flow when the vehicle accelerates. Although the passenger viewing the gaze target 14 (a book or a smartphone) on his/her hands receives a rearward inertial acceleration due to acceleration of the vehicle on his/her body, since the head is in a state of floating particularly while the passenger is gazing at his/her hands, the head pitches in the backward-tilting direction as illustrated by an arrow 11 due to the inertial acceleration. Since the passenger attempts to continue the gaze, the eyes move in accordance with the pitch motion of the head, which causes a gaze point 20 to be maintained.

As a result, since a virtual projection point P of a line of sight of the passenger moving in a direction (the forward direction or the upward direction) of an arrow 21 causes an image of the peripheral visual field 16 to move in the reverse direction (the rearward direction or the downward direction) to the direction of the arrow 21, the eyes recognize the motion in the peripheral visual field 16 as the optical flow 17. There is a risk that because of the optical flow 17 in the peripheral visual field 16, an oculomotor reflex or an opt-kinetic-response, which are subconscious control of the eyes, occurs and the eyes are moved.

Therefore, the longitudinal direction optical flow generation unit 5, which is capable of generating an optical flow in the longitudinal direction of the vehicle by use of a light string, is arranged at a point, such as the vehicle interior side of a door, that comes into the peripheral visual field 16 when the passenger is performing a gazing activity.

As described above, an image of a floor, a back surface of a front seat, or the like that comes into the peripheral visual field 16 caused by a head pitch motion due to acceleration generates the optical flow 17 flowing in a direction toward the rear (or in the downward direction) of the peripheral visual field. By outputting a light string 23 flowing from the vehicle rear side toward the vehicle front side from the longitudinal direction optical flow generation unit 5 in such a way that an optical flow 22 canceling influence of the optical flow 17 flows in a direction toward the front (or in the upward direction) of the peripheral visual field 16, the influence of the optical flow 17 occurring due to a head pitch motion is reduced. That is, a visual signal flowing in a direction toward the front that is the direction of acceleration generated by acceleration is output from the longitudinal direction optical flow generation unit 5. In other words, a visual signal flowing in a direction toward the front that is the opposite direction to the direction (the rearward direction) of inertial acceleration acting on the passenger due to acceleration is output from the longitudinal direction optical flow generation unit 5.

Because of this configuration, by preventing an unintended motion reaction of the eyes and facilitating gaze, it is possible to improve readability and visibility.

FIG. 4B is a schematic diagram of a method for providing an optical flow when the vehicle decelerates. When the vehicle decelerates, the head pitches in the forward-tilting direction as illustrated by an arrow 13 due to inertia. Since the passenger attempts to continue the gaze, the eyes move in accordance with the pitch motion of the head, which causes the gaze point 20 to be maintained. As a result, since the virtual projection point P of the line of sight of the passenger moving in a direction (the rearward direction or the downward direction) of an arrow 24 causes the image of the peripheral visual field 16 to move in the reverse direction (the forward direction or the upward direction) to the direction of the arrow 24, the eyes recognize the motion in the peripheral visual field 16 as the optical flow 17.

Therefore, the image of the floor, the back surface of the front seat, or the like that comes into the peripheral visual field 16 caused by a head pitch motion due to deceleration generates the optical flow 17 flowing in a direction toward the front (or in the upward direction) of the peripheral visual field. By outputting a light string 26 flowing from the vehicle front side toward the vehicle rear side from the longitudinal direction optical flow generation unit 5 in such a way that an optical flow 25 canceling influence of the optical flow 17 flows in a direction toward the rear (or in the downward direction) of the peripheral visual field 16, the influence of the optical flow 17 occurring due to a head pitch motion is reduced. That is, a visual signal flowing in a direction toward the rear that is the direction of acceleration generated by deceleration is output from the longitudinal direction optical flow generation unit 5. In other words, a visual signal flowing in a direction toward the rear that is the opposite direction to the direction (the forward direction) of inertial acceleration acting on the passenger due to deceleration is output from the longitudinal direction optical flow generation unit 5.

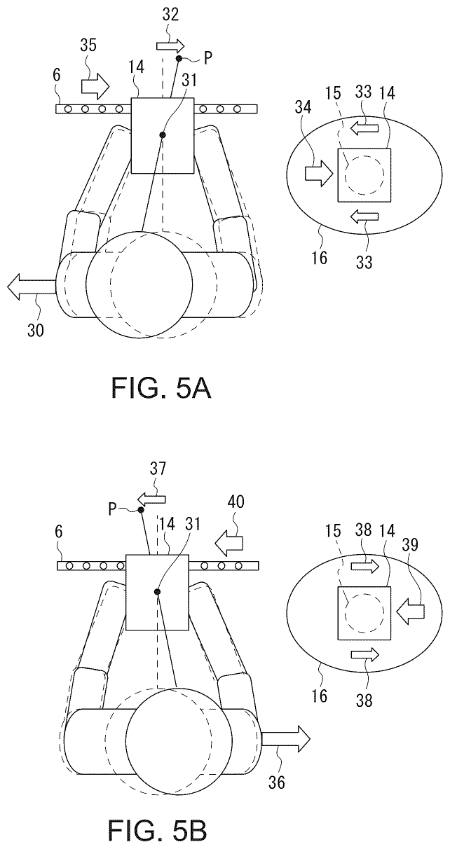

FIG. 5A is a schematic diagram of a method for providing an optical flow when the vehicle turns right. Since when the vehicle tums right, inertial acceleration acts on the passenger in the leftward direction, the passenger moves to have a roll attitude angle in the leftward direction as illustrated by an arrow 30. Since the passenger attempts to continue the gaze, the eyes move in accordance with the pitch motion of the head, which causes a gaze point 31 to be maintained. As a result, since the virtual projection point P of the line of sight of the passenger moving in a direction (the rightward direction) of an arrow 32 causes the image of the peripheral visual field 16 to move in the leftward direction, which is the reverse direction to the direction of the arrow 32, the eyes recognize the motion in the peripheral visual field 16 as an optical flow 33.

Therefore, the longitudinal direction optical flow generation unit 6, which is capable of generating an optical flow in the lateral direction of the vehicle by use of a light string, is arranged at a point coming into the peripheral visual field 16 when the passenger is performing a gazing activity. For example, a lateral direction optical flow generation unit 6 for a passenger in a rear seat is arranged on, for example, a back surface of a front seat in front of the rear seat. In addition, a lateral direction optical flow generation unit 6 for a passenger in the front seat is arranged on the dashboard or the like.

By outputting a light string 35 flowing from the vehicle left side toward the vehicle right side from the lateral direction optical flow generation unit 6 in such a way that an optical flow 34 canceling influence of the optical flow 33 flows in a direction toward the right of the peripheral visual field 16, the influence of the optical flow occurring due to a head roll motion is reduced. That is, a visual signal flowing toward the right in the vehicle width direction that is the direction of acceleration generated by right turn is output from the longitudinal direction optical flow generation unit 5. In other words, a visual signal flowing in a direction toward the right that is the opposite direction to the direction (toward the left in the vehicle width direction) of inertial acceleration acting on the passenger due to right turn is output from the longitudinal direction optical flow generation unit 5.

FIG. 5B is a schematic diagram of a method for providing an optical flow when the vehicle turns left. Since when the vehicle turns left, inertial acceleration acts on the passenger in the rightward direction, the passenger moves to have a roll attitude angle in the rightward direction as illustrated by an arrow 36. Since the passenger attempts to continue the gaze, the eyes move in accordance with the pitch motion of the head, which causes the gaze point 31 to be maintained. As a result, since the virtual projection point P of the line of sight of the passenger moving in a direction (the leftward direction) of an arrow 37 causes the image of the peripheral visual field 16 to move in such a manner as to flow in the rightward direction, which is the reverse direction to the direction of the arrow 37, the eyes recognize the motion in the peripheral visual field 16 as an optical flow 38.

Therefore, by outputting a light string 40 flowing from the vehicle right side toward the vehicle left side from the lateral direction optical flow generation unit 6 in such a way that an optical flow 39 canceling influence of the optical flow 38 flows in a direction toward the left of the peripheral visual field 16, the influence of the optical flow occurring due to a head roll motion is reduced. That is, a visual signal flowing toward the left in the vehicle width direction that is the direction of acceleration generated by left turn is output from the longitudinal direction optical flow generation unit 5. In other words, a visual signal flowing in a direction toward the left that is the opposite direction to the direction (toward the right in the vehicle width direction) of inertial acceleration acting on the passenger due to left turn is output from the longitudinal direction optical flow generation unit 5.

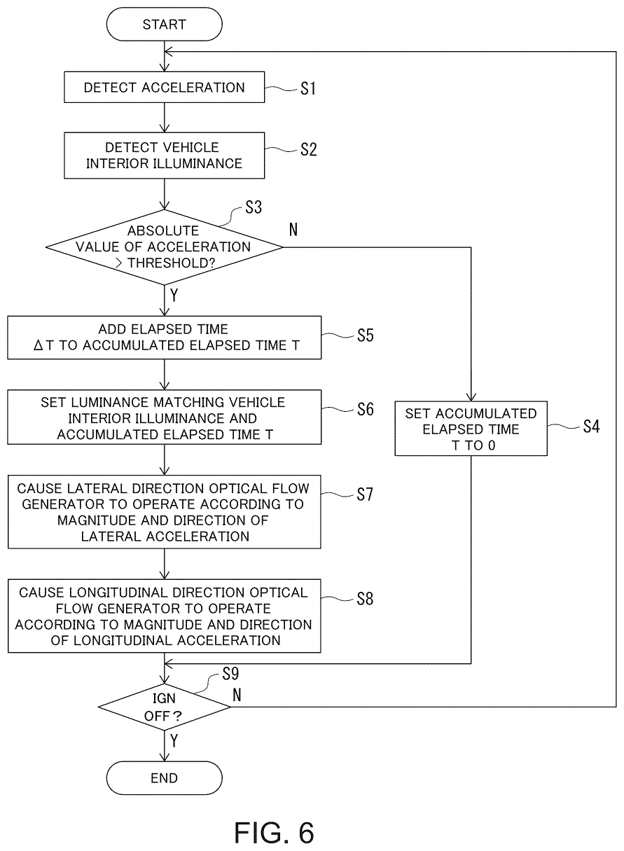

FIG. 6 is a flowchart of an example of an optical flow generation method of the embodiment.

In step S1, the longitudinal acceleration sensor 2 detects longitudinal acceleration ax. In addition, the lateral acceleration sensor 3 detects lateral acceleration ay.

In step S2, the illuminance sensor 4 detects illuminance in the interior of the vehicle (that is, brightness in the vehicle interior).

In step S3, the calculation device 7 determines whether or not at least one of an absolute value of the longitudinal acceleration ax and an absolute value of the lateral acceleration ay that are detected in step S1 is greater than a predetermined threshold value. When both the absolute value of the longitudinal acceleration ax and the absolute value of the lateral acceleration ay are less than or equal to the threshold value (step S3: N), the process proceeds to step S4.

In step S4, the calculation device 7 sets an accumulated elapsed time T to 0. Subsequently, the process proceeds to step S9.

When in the determination in step S3, at least one of the absolute value of the longitudinal acceleration ax and the absolute value of the lateral acceleration ay is greater than the threshold value (step S3: Y), the process proceeds to step S5.

In step S5, the calculation device 7 updates the accumulated elapsed time T by adding an elapsed time Δt to the accumulated elapsed time T. The elapsed time Δt may be, for example, time length of one cycle of a control loop in which steps S1 to S9 are repeated.

In step S6, the calculation device 7 sets luminance of an optical flow that the longitudinal direction optical flow generation unit 5 and/or the lateral direction optical flow generation unit 6 generates, according to the accumulated elapsed time T and the illuminance in the vehicle interior acquired in a flow S20. For example, the calculation device 7 may increase the luminance of the optical flow to a higher value when the accumulated elapsed time T is short than when the accumulated elapsed time T is long. For example, the shorter the accumulated elapsed time T is, the higher the calculation device 7 may increase the luminance of the optical flow. Because of this configuration, it is possible to achieve an effect of facilitating reduction in an eye movement response by generation of an optical flow.

When the absolute value of the lateral acceleration ay is greater than the threshold value, the calculation device 7 generates a lateral optical flow by causing the lateral direction optical flow generation unit 6 to operate according to the magnitude and direction of the lateral acceleration ay, in step S7. For example, the calculation device 7 may generate a faster optical flow when the lateral acceleration ay is large than when the lateral acceleration ay is small. For example, the larger the lateral acceleration ay is, the faster optical flow the calculation device 7 may generate. For example, the calculation device 7 may generate an optical flow having speed proportional to the magnitude of the lateral acceleration ay.

When the absolute value of the longitudinal acceleration ax is greater than the threshold value, the calculation device 7 generates a longitudinal optical flow by causing the longitudinal direction optical flow generation unit 5 to operate according to the magnitude and direction of the longitudinal acceleration ax, in step S8. For example, the calculation device 7 may generate a faster optical flow when the longitudinal acceleration ax is large than when the longitudinal acceleration ax is small. For example, the larger the longitudinal acceleration ax is, the faster optical flow the calculation device 7 may generate. For example, the calculation device 7 may generate an optical flow having speed proportional to the magnitude of the longitudinal acceleration ax. Subsequently, the process proceeds to step S9.

In step S9, the calculation device 7 determines whether or not an ignition key of the vehicle has been switched to an off state. When the ignition key has not been switched to the off state (step S9: N), the process returns to step S1. When the ignition key is switched to the off state (step S9: Y), the process terminates.

Although in the above description, a case where the front surface of a passenger seat faces the front in the longitudinal direction of the vehicle is described, the present invention is applicable to a case where the front surface of a passenger seat faces in the lateral direction of the vehicle. In this case, the same effect can be achieved by swapping the longitudinal direction and the lateral direction of the vehicle in the above description.

In addition, in a case where the front surface of a passenger seat faces the rear in the longitudinal direction of the vehicle, the same effect can also be achieved by swapping the forward direction and the rearward direction, and by swapping the leftward direction and the rightward direction in the above description.

### Advantageous Effects of Embodiment

(1) The longitudinal acceleration sensor 2 and the lateral acceleration sensor 3 detect acceleration of a vehicle. The calculation device 7 outputs visual signals flowing along directions of acceleration of the vehicle from the longitudinal direction optical flow generation unit 5 and the lateral direction optical flow generation unit 6 based on output signals from the longitudinal acceleration sensor 2 and the lateral acceleration sensor 3, respectively.

Because of this configuration, it is possible to generate an optical flow canceling influence of an optical flow that is generated in an area of a peripheral visual field of a passenger when the head of the passenger is moved due to acceleration of the vehicle. As a result, visibility and readability in a gaze in the central vision of the passenger can be prevented from being reduced.

(2) The calculation device 7 may perform control in such a way that speed at which a visual signal flows matches acceleration.

Because of this configuration, it is possible to generate an optical flow canceling influence of an optical flow in the peripheral visual field of the passenger that is generated by a motion of the passenger proportional to the acceleration of the vehicle, by making speed of the optical flow to be generated proportional to acceleration generated in the vehicle.

(3) The longitudinal direction optical flow generation unit 5 may output a visual signal flowing toward the front in the longitudinal direction of the vehicle when the vehicle accelerates and a visual signal flowing toward the rear in the longitudinal direction of the vehicle when the vehicle decelerates.

Because of this configuration, it is possible to define a direction of an optical flow in the peripheral visual field for canceling influence of an optical flow that is generated in the peripheral visual field by a motion of the head of the passenger generated due to acceleration and deceleration of the vehicle.

(4) The lateral direction optical flow generation unit 6 may output a visual signal flowing toward the right in the vehicle width direction of the vehicle when the vehicle turns right and a visual signal flowing toward the left in the vehicle width direction of the vehicle when the vehicle turns left.

Because of this configuration, it is possible to define a direction of an optical flow in the peripheral visual field for canceling influence of an optical flow that is generated in the peripheral visual field by a motion of the head of the passenger generated due to a lateral motion (turn) of the vehicle.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

1. A visual signal generation method comprising:
detecting acceleration of a vehicle by a sensor; and
outputting a visual signal flowing toward one direction based on a direction of an inertial acceleration acting on a passenger from an indicator visually recognizable by the passenger of the vehicle based on an output signal from the sensor.

2. The visual signal generation method according to claim 1, further comprising performing a control in such a way that a speed at which the visual signal flows matches a magnitude of the acceleration.

3. The visual signal generation method according to claim 2, wherein the visual signal generation method outputs the visual signal flowing toward a front in a longitudinal direction of the vehicle when the vehicle accelerates and outputs the visual signal flowing toward a rear in the longitudinal direction of the vehicle when the vehicle decelerates.

4. The visual signal generation method according to claim 2, wherein
the visual signal generation method outputs the visual signal flowing toward a right in a vehicle width direction of the vehicle when the vehicle turns right and outputs the visual signal flowing toward a left in the vehicle width direction of the vehicle when the vehicle turns left.

5. A vehicle comprising:
a sensor configured to detect an acceleration of the vehicle; and
an indicator configured to output a visual signal flowing toward one direction based on a direction of an inertial acceleration acting on a passenger based on an output signal from the sensor,
the indicator being arranged at a position at which the indicator is visually recognizable by the passenger of the vehicle.
